(19) United States
(12) Patent Application Publication
(10) Pub. No.: US 2014/0360935 A1
(43) Pub. Date: Dec. 11, 2014

(54) METHOD AND DEVICE FOR TREATING BALLAST WATER

(71) Applicant: Evonik Industries AG, Essen (DE)

(72) Inventors: Jürgen Meier, Bad Vilbel (DE); Frank Dieter Kuhn, Gelnhausen (DE); Sven Siebenlist, Aschaffenburg (DE)

(73) Assignee: EVONIK INDUSTRIES AG, Essen (DE)

(21) Appl. No.: 14/367,930

(22) PCT Filed: Nov. 22, 2012
(86) PCT No.: PCT/EP2012/073285

§ 371 Date: Jun. 22, 2014

(30) Foreign Application Priority Data
Dec. 23, 2011 (EP) 11195602.5

(51) Int. Cl. B63J 4/00; C02F 1/50; C02F 3/34

(52) U.S. Cl. CPC B63J 4/002; C02F 3/342; C02F 1/50; C02F 2101/10
USPC 210/632; 210/85; 210/87

(57) ABSTRACT

For treatment of ballast water, on uptake of ballast water into a ship, equilibrium peracetic acid and catalase are added to the ballast water, wherein equilibrium peracetic acid is added in an amount of from 5 to 50 mg/l peracetic acid and catalase is added in an amount which within 120 h breaks down the content of the hydrogen peroxide introduced with the equilibrium peracetic acid to less than 2 mg/l in the ballast water.

For treating the ballast water, a device is suitable that comprises a ballast water tank, a conduit for filling the ballast water tank and a conduit for emptying the ballast water tank, wherein metering devices for equilibrium peracetic acid and catalase are connected to the conduit for filling the ballast water tank, and a metering device for a reducing agent is connected to the conduit for emptying the ballast water tank.

The invention relates to a method and a device for treating ballast water on ships.

Most freighters are equipped with ballast water tanks which are filled with ballast water when the ship is sailing without a load or with a low load in order to ensure a stable position of the ship and to avoid the ship capsizing. When the ballast water tanks are filled, microorganisms, such as bacteria, plant and animal plankton, and also spores thereof, are taken up together with the water and transported over great distances by emptying the ballast water tanks in a different harbour or coastal waters. The spread of organisms in this manner into ecosystems outside their natural habitat is undesirable and can lead to considerable problems.

Such a spread of organisms with ballast water can be prevented by treating the ballast water with a biocide.

U.S. Pat. No. 5,256,423 describes a method for killing cysts of poisonous plankton by addition of 10 to 500 ppm of hydrogen peroxide or hydrogen peroxide-forming compounds to ballast water. Hydrogen peroxide, however, does not have a sufficiently wide biocidal activity, and so by treating ballast water with hydrogen peroxide, the requirements of the international maritime organization (IMO) of an effective ballast water treatment according to the D2 standard of the “International Convention for the Control and Management of Ships' Ballast Water and Sediments” (2004) cannot always be met.

EP 1 006 084 describes a method for treating ballast water by addition of 0.1 to 200 ppm of a percarboxylic acid. The percarboxylic acid is preferably peracetic acid in the form of an equilibrium peracetic acid that has a substantially higher biocidal activity than hydrogen peroxide.

Y. de Lafontaine et al., Ecotoxicology and Enviromental Safety 71 (2008) 355-369 found a biocidal activity for peracetic acid in the Microtox® test that is more than a hundredfold higher than for hydrogen peroxide. A ballast water treatment using equilibrium peracetic acid of trade mark PERACLEAN® Ocean was approved by the IMO for ballast water treatment.

EP 1 671 932 describes a method for treating ballast water by adding from 10 to 500 ppm of hydrogen peroxide or hydrogen peroxide-forming compounds in combination with iron(II) ions, catalase or iodine. The method described in EP 1 671 932 is not approved by the IMO for ballast water treatment.

The inventors of the present invention have now found that the effectiveness of the ballast water treatment with equilibrium peracetic acid known from EP 1 006 084 may be further increased if catalase is added to the ballast water together with equilibrium peracetic acid. Advantages result most notably for ballast water at a low temperature and at low salinity of the ballast water. In addition, the addition of catalase together with equilibrium peracetic acid simplifies removal of unused peracetic acid before treated ballast water is discharged.

The invention therefore relates to a method for treating ballast water on a ship, in which, on uptake of ballast water into the ship, equilibrium peracetic acid and catalase are added to the ballast water, wherein equilibrium peracetic acid is added in an amount from 5 to 50 mg/l peracetic acid and catalase is added in an amount which within 120 h breaks down the content of the hydrogen peroxide introduced with the equilibrium peracetic acid to less than 2 mg/l in the ballast water.

The invention further relates to a device for treating ballast water of a ship, comprising a ballast water tank, a conduit for filling the ballast water tank and a conduit for emptying the ballast water tank, wherein metering devices for equilibrium peracetic acid and catalase are connected to the conduit for filling the ballast water tank, and a metering device for a reducing agent is connected to the conduit for emptying the ballast water tank.

In the method according to the invention, equilibrium peracetic acid and catalase are added to the ballast water on uptake into the ship.

Equilibrium peracetic acid designates, according to the invention, a mixture which consists essentially of water, hydrogen peroxide, acetic acid and peracetic acid and in which these components are in a chemical equilibrium in accordance with equation (I).

CH₃COOH+H₂O₂⇄CH₃COOOH+H₂O (I)

Preferably, the equilibrium peracetic acid contains about 15% by weight peracetic acid, about 14% by weight hydrogen peroxide and about 27% by weight acetic acid. A suitable equilibrium peracetic acid having this composition is obtainable from Evonik Industries under the brand name PERACLEAN® Ocean.

The equilibrium peracetic acid preferably contains up to 5% by weight of a mineral acid, preferably polyphosphoric acid, in addition to water, hydrogen peroxide, acetic acid and peracetic acid. The addition of the mineral acid accelerates the establishment of the chemical equilibrium in accordance with equation (I). The equilibrium peracetic acid preferably additionally contains up to 1% by weight of a stabilizer complexing metal ions, wherein pyrophosphates and chelating phosphonic acids are particularly preferred.

The equilibrium peracetic acid is added to the ballast water in an amount from 5 to 50 mg of peracetic acid per litre of ballast water, preferably in an amount from 10 to 25 mg/l. The peracetic acid is preferably added into a ballast water stream which is charged to ballast water tanks of a ship.

In the method according to the invention, catalase is added to the ballast water in an amount which within 120 h breaks down the content of the hydrogen peroxide introduced with the equilibrium peracetic acid to less than 2 mg/l in the ballast water. Preferably, enough catalase is added such that the hydrogen peroxide concentration falls to a value of less than 2 mg/l as soon as within 24 h. The amount of catalase required therefor depends on the amount of added equilibrium peracetic acid, the hydrogen peroxide content in the added equilibrium peracetic acid, the activity of the catalase used, and also the temperature and the salt content of the ballast water and can easily be determined by routine experiments. Preferably, catalase is added in an amount from 0.1 to 40 units per litre of ballast water (U/l).

All catalases that catalyse a breakdown of hydrogen peroxide according to equation (II) can be used for the method according to the invention.

2H₂O₂→2H₂O+O₂ (II)

Preferably, an aqueous solution of a catalase is used. A catalase obtainable under the brand name OPTIMASE® CA 400L from Genencor is particularly suitable.

The order in which equilibrium peracetic acid and catalase are added to the ballast water can be selected as desired. The catalase is preferably added separately from the equilibrium peracetic acid. Preferably, the catalase is added to the same ballast water stream as the equilibrium peracetic acid, wherein the addition points for equilibrium peracetic acid and catalase are separate from one another in space. Preferably, the addition proceeds at addition points which are separated from one another spatially so far that the first component added is mixed with the ballast water before the second component is added.

The temperature of the ballast water is not subject to any restrictions in the method according to the invention. Preferably, the ballast water, on uptake into the ship, has a temperature in the range from 0 to 22° C., particularly preferably in the range from 0 to 18° C. In this temperature range, a greater effectiveness is achieved using the method according to the invention than using the method according to the prior art, in such a manner that using smaller amounts of peracetic acid, a sufficiently effective treatment of ballast water is achieved. Heating of the ballast water is therefore not necessary.

The ballast water can be a fresh water, e.g. from a lake or river, a brackish water of low salinity, or a sea water of high salinity. Preferably, the ballast water, on uptake into the ship, has a salinity in the range from 0 to 16. The expression salinity designates in this case the dimensionless salinity S on the Practical Salinity Scale 1978. In this range of salinity, in the method according to the invention, surprisingly, a slower degradation of peracetic acid is achieved than in the method known from EP 1 006 084, in such a manner that using smaller amounts of peracetic acid, a sufficiently effective treatment of ballast water is achieved.

In a preferred embodiment of the method according to the invention, the peracetic acid content is decreased to less than 1 mg/l by adding a reducing agent before treated ballast water is drained off. Preferably, reducing agents such as sodium sulphite, sodium hydrogensulphite or sodium thiosulphate are used, which reduce peracetic acid to acetic acid in the course of a few seconds. Particularly preferred reducing agents are sodium sulphite and sodium hydrogensulphite. In this embodiment, the method according to the invention has the advantage that a smaller amount of reducing agent is required for a virtually complete removal of peracetic acid, since no additional consumption, or only a small additional consumption of reducing agent owing to a reduction of hydrogen peroxide results.

The addition of the reducing agent preferably proceeds into a ballast water stream which is discharged from ballast water tanks of a ship.

Preferably the content of peracetic acid is determined in the treated ballast water, preferably using an amperometric sensor, and the addition of the reducing agent is controlled using the determined peracetic acid content. The method according to the invention in this embodiment has the advantage that even using simply built sensors for peracetic acid that have a cross-sensitivity to hydrogen peroxide, the addition of the reducing agent can be controlled sufficiently accurately, so that the permissible residual content of peracetic acid can be complied with without overdosing reducing agent.

The invention further relates to a device for treating ballast water of a ship, using which device the method according to the invention may be carried out. The device comprises at least one ballast water tank, a conduit for filling the ballast water tank and a conduit for emptying the ballast water tank. Metering devices for equilibrium peracetic acid and catalase are connected to the conduit for filling the ballast water tank. A metering device for a reducing agent is connected to the conduit for emptying the ballast water tank.

The conduit for filling the ballast water tank and the conduit for emptying the ballast water tank can be constructed as separate conduits. However, preferably, the conduits are combined in such a manner that, in sections, a common conduit for filling and emptying the ballast water tank is used. Preferably, in such a common conduit section appliances are arranged which are used both on filling the ballast water tank and also on emptying the ballast water tank, in particular a pump for transporting the ballast water and measuring devices, such as a flow metering device, a temperature measuring device and/or a measuring device for salinity. The device according to the invention can comprise a plurality of ballast water tanks which have a common conduit for filling and a common conduit for emptying.

The metering device for equilibrium peracetic acid preferably comprises a storage vessel for equilibrium peracetic acid and a control valve or a controllable pump for a continuous metering of equilibrium peracetic acid into the conduit for filling the ballast water tank. Preferably a mass flow meter or a volume flow meter is arranged between the control valve or the controllable pump and the conduit for filling the ballast water tank, by which the metered amount of equilibrium peracetic acid may be measured and the control valve or the controllable pump actuated, in order to control the amount of metered equilibrium peracetic acid. The metering device for equilibrium peracetic acid preferably additionally comprises a nonreturn valve which prevents ballast water being able to pass into a storage vessel for equilibrium peracetic acid.

The metering device for catalase preferably comprises in a similar manner a storage vessel for an aqueous solution of catalase and a control valve or a controllable pump, and also preferably a mass flow meter or a volume flow meter for the metering of catalase and controlling the amount of metered catalase. A mass flow meter or volume flow meter, however, can be dispensed with if the controllable pump used is a positive-displacement metering pump such as, for example, a membrane pump, gear pump or piston pump, which allows to set a calculated volumetric flow rate.

The conduit for filling the ballast water tank is preferably provided with a flow metering device by which the metering devices for equilibrium peracetic acid and catalase are actuated. Such an actuation ensures that on intake of ballast water, even in the event of fluctuations of the ballast water stream, the desired content of peracetic acid and catalase in the ballast water is achieved.

Preferably, the conduit for filling the ballast water tank is additionally provided with a temperature measuring device and/or a measuring device for salinity, by which the metering device for catalase is actuated. The salinity can be measured on the basis of density measurements and preferably on the basis of electrical conductivity using a conductivity sensor. Via such an actuation of the metering device for catalase, the amount of metered catalase may be set in accordance with the dependence of catalytic activity on temperature and salinity and thus the desired content of hydrogen peroxide in the treated ballast water may be reliably met with a low consumption of catalase.

The metering device for reducing agent preferably comprises a storage vessel for an aqueous solution of the reducing agent and a control valve or a controllable pump for continuous metering of reducing agent into the conduit for emptying the ballast water tank. Between the control valve or the controllable pump and the conduit for emptying the ballast water tank there is preferably arranged a mass flow meter or a volume flow meter by which the metered amount of reducing agent may be measured and the control valve or the controllable pump may be actuated in order to control the amount of metered reducing agent. However, a mass flow meter or a volume flow meter can be dispensed with if the controllable pump used is a positive-displacement metering pump such as, for example, a membrane pump, gear pump or piston pump, which allows a calculated volumetric flow rate to be set.

The conduit for emptying the ballast water tank is preferably provided with a flow metering device and a sensor for the peracetic acid content, by which the metering device for a reducing agent is actuated. Via such an actuation of the metering device for a reducing agent it is ensured that even in the event of fluctuations of the ballast water stream, the amount of reducing agent required for a virtually complete reaction of peracetic acid is metered without overdosing reducing agent, and the ballast water after the reduction still has a sufficient content of dissolved oxygen and does not have environmentally hazardous contents of peracetic acid or reducing agent.

The sensor for the peracetic acid content is preferably an amperometric sensor, particularly preferably a sensor at which peracetic acid is reduced in accordance with equation (III).

CH₃COOOH+2H⁺+2e⁻CH₃COOH+H₂O (III)

Suitable amperometric sensors for peracetic acid are obtainable commercially, for example from ProMinent® under the name DULCOTEST® PAA. Commercially offered amperometric sensors for determining the total chlorine content are likewise suitable, for example the sensors offered by ProMinent® under the name DULCOTEST® CTE-1. The use of an amperometric sensor for determining the peracetic acid content makes possible a substantially automated operation of the device according to the invention by staff such as, for example, a ship's crew, which has no training in operating analytical instruments.

The sensor for the peracetic acid content is preferably arranged in a side stream of the conduit for emptying the ballast water tank in order to prevent damage of the sensor due to solids entrained in the water stream. For the same purpose, a filter is preferably arranged in the side stream upstream of the sensor.

The device according to the invention preferably comprises a control appliance which calculates an amount of reducing agent for decreasing the peracetic acid content to a desired value from the flow rate of the ballast water on emptying the ballast water tank and from the concentration of peracetic acid in the ballast water, and actuates the metering device for the reducing agent. The control appliance can be constructed as a hard-wired controller or as a calculation and control program on a process control computer. The amount of reducing agent can be calculated from the flow rate of the ballast water and the peracetic acid concentration in the ballast water using empirical conversion factors determined by experiments or using conversion factors calculated from the stoichiometry of the reduction reaction. For a salt-free ballast water which no longer contains hydrogen peroxide and a reduction using an aqueous solution of sodium sulphite, the conversion factors can be calculated on the basis of reaction equation (IV).

CH₃COOOH+Na₂SO₃→CH₃COOH+Na₂SO₄ (IV)

Similarly, for a reduction using sodium hydrogensulphite, the conversion factors can be calculated on the basis of reaction equation (V).

CH₃COOOH+NaHSO₃→CH₃COOH+NaHSO₄ (V)

For liquid reducing agents which are metered via a positive-displacement metering pump, the volumetric flow rate to be set on the metering pump can be calculated directly from the calculated amount of reducing agent and the metering pump can be actuated accordingly.

In a preferred embodiment of the device according to the invention, the conduit for emptying the ballast water tank is also provided with a measuring device for salinity, using which the metering device for a reducing agent is actuated. Preferably, the metering device is actuated by a control appliance in which the required amount of reducing agent is calculated in dependence on salinity. Preferably, in this case, the amount of reducing agent calculated for a salt-free ballast water is corrected using a correction factor for the salinity determined by experiments. For saline ballast water and reduction using an aqueous solution of sodium sulphite, the amount of reducing agent calculated for a salt-free ballast water is preferably increased by a fraction proportional to the salinity. Taking into account the salinity on metering the reducing agent makes possible a reliable decrease in peracetic acid content to below preset limiting values even in the case of a changeable salt content of the ballast water, without an overdose of reducing agent occurring.

In a particularly preferred embodiment of the device according to the invention, the conduit for emptying the ballast water tank is provided with an additional sensor for the hydrogen peroxide content, and the device according to the invention comprises a control appliance which calculates the amount of reducing agent for decreasing the peracetic acid and hydrogen peroxide contents to a desired value from the flow rate of the ballast water on emptying the ballast water tank and the peracetic acid and hydrogen peroxide concentrations in the ballast water, and actuates the metering device for the reducing agent.

In a further preferred embodiment of the device according to the invention, a separating device for particles having a size in the range from 2 to 100 μm is arranged in the conduit for filling the ballast water tank upstream of the metering devices for equilibrium peracetic acid and catalase. Suitable separating devices in this case are filters and hydrocyclones. Via a separation of particles in this size range, the demand for equilibrium peracetic acid and catalase for the ballast water treatment may be decreased and the effectiveness of the method in removal of living organisms from the ballast water may be further improved.

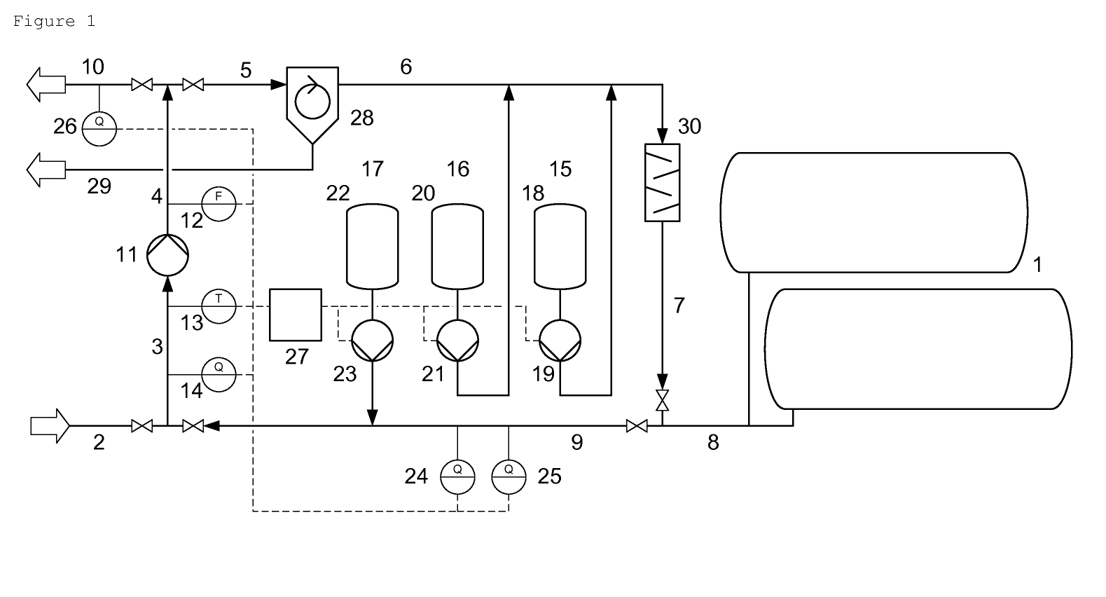

FIG. 1 shows a preferred embodiment of the device according to the invention in which, in sections, a common conduit is used for filling and emptying the ballast water tank. The device comprises ballast water tanks (1). Conduit sections (2) to (8) form a conduit for filling the ballast water tanks. Conduit sections (8), (9), (3), (4) and (10) form a conduit for emptying the ballast water tanks. The conduit for filling the ballast water tanks and the conduit for emptying the ballast water tanks in this case have common sections (3), (4) and (8).

In common sections (3) and (4), a pump (11) is arranged for transporting ballast water into the ballast water tanks and from the ballast water tanks. In common sections (3) and (4) also a flow metering device (12), a temperature measuring device (13) and measuring device (14) for salinity are arranged.

A metering device (15) for equilibrium peracetic acid and a metering device (16) for catalase are connected to conduit section (6) of the conduit for filling the ballast water tanks. A metering device (17) for a reducing agent is connected to conduit section (9) of the conduit for emptying the ballast water tanks. The metering device (15) for equilibrium peracetic acid comprises a storage vessel (18) for equilibrium peracetic acid and a controllable pump (19). The metering device (16) for catalase comprises a storage vessel (20) for an aqueous solution of catalase and a controllable pump (21). The metering device (17) for a reducing agent comprises a storage vessel (22) for an aqueous solution of the reducing agent and a controllable pump (23).

In addition, an amperometric sensor (24) for peracetic acid and a sensor (25) for hydrogen peroxide are connected to conduit section (9) of the conduit for emptying the ballast water tanks. Alternatively, the two sensors (24, 25) can also be connected to conduit section (8). In this alternative, using the two sensors, the concentrations of peracetic acid and hydrogen peroxide in the treated ballast water can also be monitored on filling the ballast water tanks.

A second amperometric sensor (26) for peracetic acid is connected to conduit section (10) of the conduit for emptying the ballast water tanks. A second sensor for hydrogen peroxide can optionally also be connected to conduit section (10).

The device of FIG. 1 has a process control computer (27) which actuates the controllable pump (19) for metering equilibrium peracetic acid using the measured value of the flow metering device (12). The process control computer (27) additionally actuates the controllable pump (21) for metering the aqueous solution of catalase using the measured values of the flow metering device (12), the temperature measuring device (13) and the measuring device (14) for salinity, and actuates the controllable pump (23) for metering the aqueous solution of the reducing agent using the measured values of the flow metering device (12), the measuring device (14) for salinity, the amperometric sensor (24) for peracetic acid and the sensor (25) for hydrogen peroxide. The process control computer (27) additionally monitors the compliance with limiting values for the content of hydrogen peroxide and peracetic acid in the ballast water on emptying the ballast water tanks, using the measured values of the sensor (25) for hydrogen peroxide and the second amperometric sensor (26) for peracetic acid. For this monitoring, the measured values of an additional sensor for hydrogen peroxide which is connected to conduit section (10) can also be used.

The device of FIG. 1 additionally comprises a hydrocyclone (28), by which, on filling of the ballast water tanks, particles having a size of from 2 to 100 μm are separated from the ballast water stream and discharged with a substream via line (29). The device of FIG. 1 additionally comprises a mixing device constructed as a static mixer (30) in the conduit for filling the ballast water tanks downstream of the metering devices (15) and (16), by which the metered equilibrium peracetic acid and the metered catalase are distributed in the ballast water before the ballast water is fed to the ballast water tanks (1).

On the one hand, the device according to the invention allows for an effective and reliable treatment of ballast water, in which microorganisms are extensively killed on intake of ballast water into the ship, and on the other hand, it ensures in a simple manner and with low consumption of chemicals that on discharge of the treated ballast water the peracetic acid and hydrogen peroxide contents in the ballast water are so low that they do not have any disadvantageous effects on the body of water and the organisms living therein, into which the treated ballast water is drained off.

The examples hereinafter clarify the invention, but without restricting the subject matter of the invention.

### EXAMPLES

Peracetic acid stability in treated water

The effect of a joint addition of equilibrium peracetic acid and catalase on the decrease of hydrogen peroxide and peracetic acid contents was studied for low-salt and high-salt water at different temperatures. For this purpose, tap water or sea water from the North Sea (Texel/NL, salinity 25.9) were admixed with 150 mg/l of equilibrium peracetic acid PERACLEAN® Ocean and varying amounts of a catalase solution Optimase® CA 400L from Genencor (specific activity 3743 units/g of solution) at 23° C. or 2° C., wherein the catalase solution, for more accurate metering, was diluted by the factor 1000 or 10,000 with demineralised water prior to addition. Subsequently, the treated water was stored in glass bottles at the stated temperatures and the hydrogen peroxide and peracetic acid contents were followed by sampling and photometric determination of the contents of hydrogen peroxide (reagent dipotassium titanium oxide dioxalate dihydrate, absorption at 385 nm) and peracetic acid (reagent 2,2′-azinobis(3-ethylbenzothiazoline-6-sulphonic acid (ABTS), absorption at 412 nm).

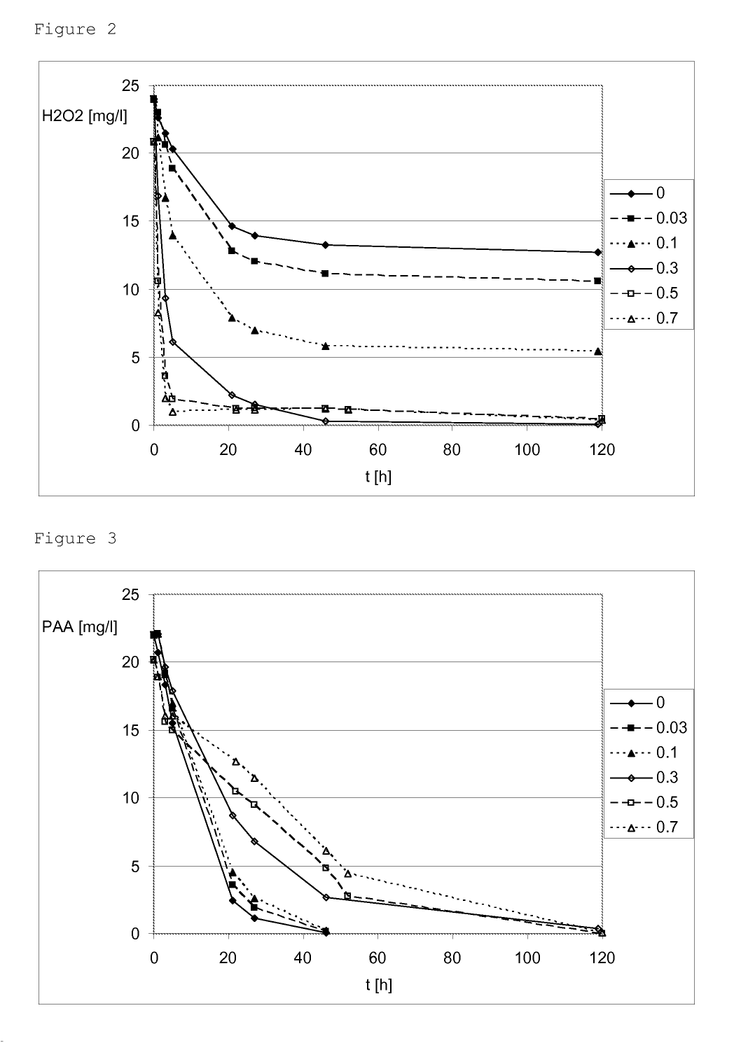

FIGS. 2 and 3 show the decrease in hydrogen peroxide and peracetic acid (PAA) contents in treated tap water at 23° C. on addition of the amount of Optimase® CA 400L stated in the right-hand column in μl/l.

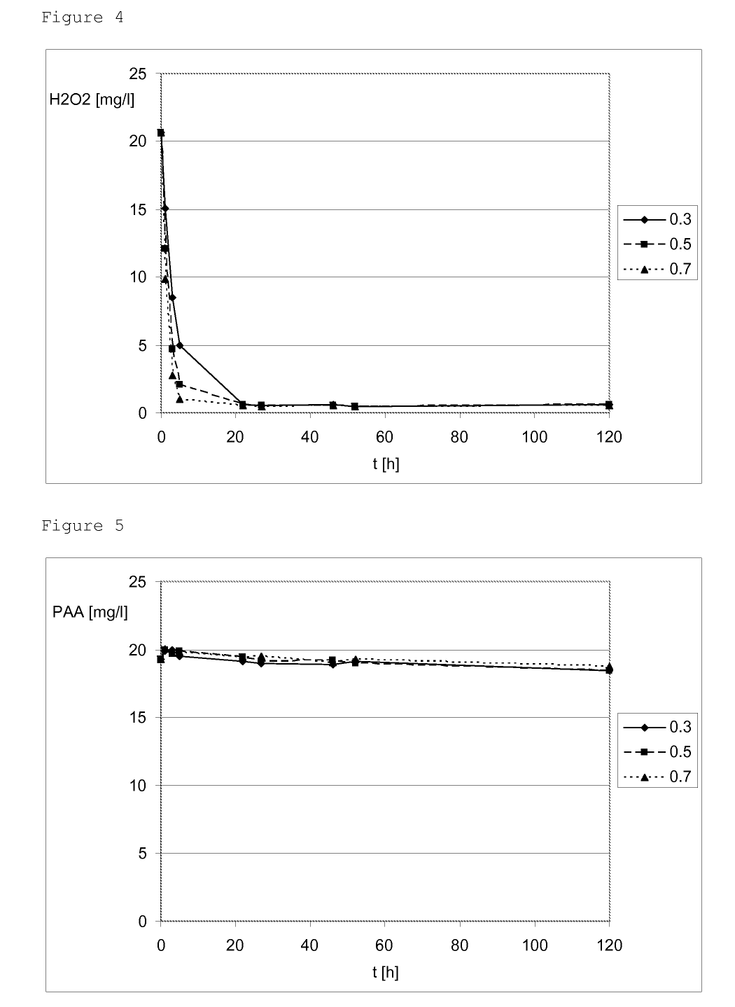

FIGS. 4 and 5, in a similar manner, show the decrease in hydrogen peroxide and peracetic acid contents in treated tap water at 2° C.

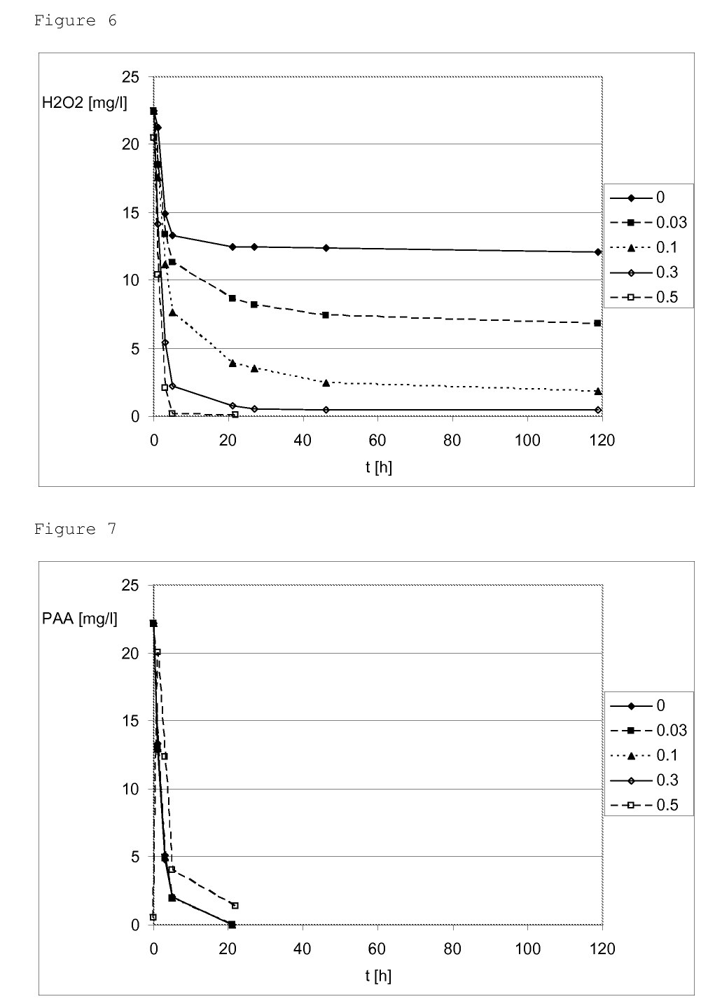

FIGS. 6 and 7 show similarly the decrease in hydrogen peroxide and peracetic acid content in treated sea water at 23° C.

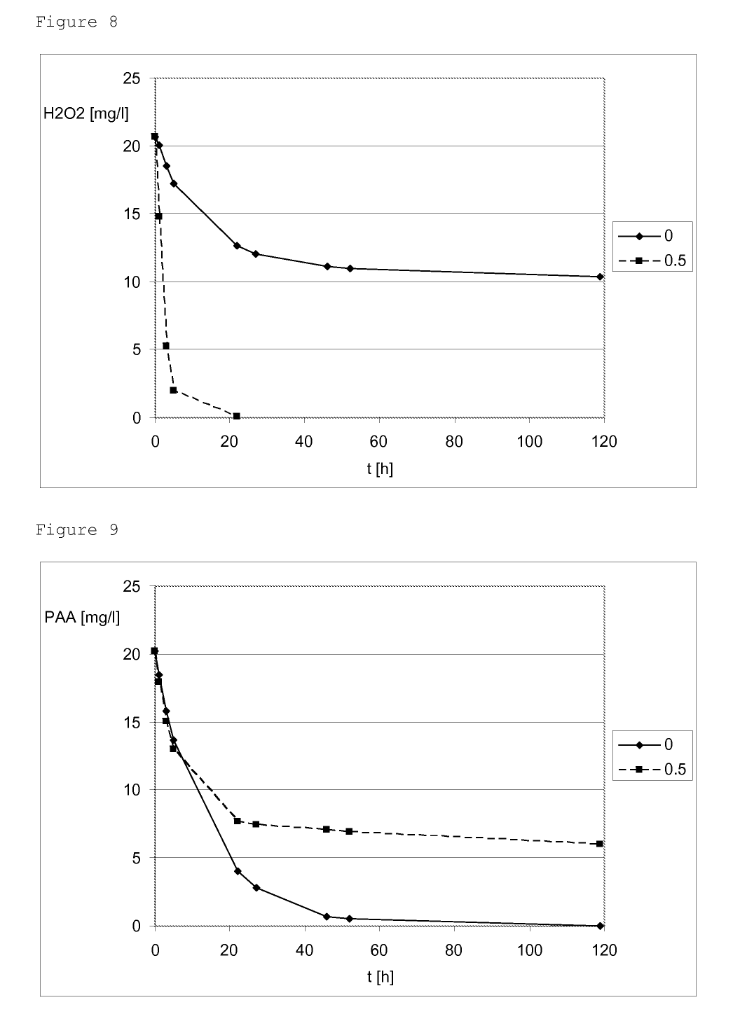

FIGS. 8 and 9 show the decrease in hydrogen peroxide and peracetic acid content in treated sea water at 2° C.

The figures show that, with an increasing amount of catalase, the hydrogen peroxide content decreases more rapidly, since hydrogen peroxide is decomposed by the catalase. However, the figures also show that, surprisingly, with an increasing amount of catalase, the peracetic acid content decreases more slowly. The effect is particularly pronounced at a low salt content (FIG. 3), and also in sea water at low temperature (FIG. 9). Therefore, since peracetic acid has a much greater biocidal activity than hydrogen peroxide in ballast water treatment, the biocidal activity of equilibrium peracetic acid in ballast water treatment surprisingly can be increased through addition of catalase, in such a manner that effective treatment is possible with lower amounts of equilibrium peracetic acid, or, for the same amount of equilibrium peracetic acid, a higher killing rate of organisms is achieved.

1-15. (canceled)

16. A method for treating ballast water on a ship, wherein, on uptake of ballast water into the ship, equilibrium peracetic acid and catalase are added to the ballast water, wherein equilibrium peracetic acid is added in an amount from 5 to 50 mg/l peracetic acid and catalase is added in an amount which, within 120 h, breaks down the content of the hydrogen peroxide introduced with the equilibrium peracetic acid to less than 2 mg/l in the ballast water.

17. The method of claim 16, wherein the ballast water, on uptake into the ship, has a temperature in the range from 0 to 18° C.

18. The method of claim 16, wherein the ballast water, on uptake into the ship, has a salinity in the range from 0 to 16.

19. The method of claim 16, wherein catalase is added in an amount from 0.1 to 40 units/l.

20. The method of claim 16, wherein the peracetic acid content is decreased to less than 1 mg/l by adding a reducing agent before treated ballast water is discharged.

21. The method of claim 20, wherein sodium sulphite or sodium hydrogen sulphite is added as reducing agent.

22. The method of claim 20, wherein the peracetic acid content is determined in the treated ballast water using an amperometric sensor and the addition of reducing agent is controlled using the determined content of peracetic acid.

23. A device for treating ballast water of a ship, comprising at least one ballast water tank, a conduit for filling the ballast water tank and a conduit for emptying the ballast water tank, wherein metering devices for equilibrium peracetic acid and catalase are connected to the conduit for filling the ballast water tank, and a metering device for a reducing agent is connected to the conduit for emptying the ballast water tank.

24. The device of claim 23, wherein the conduit for filling the ballast water tank is provided with a flow meter actuating the metering devices for equilibrium peracetic acid and catalase.

25. The device of claim 23, wherein the conduit for filling the ballast water tank is provided with a temperature measuring device actuating the metering device for catalase.

26. The device of claim 23, wherein the conduit for filling the ballast water tank is provided with a measuring device for salinity actuating the metering device for catalase.

27. The device of claim 23, wherein the conduit for emptying the ballast water tank is provided with a flow meter and a sensor for the peracetic acid content actuating the metering device for a reducing agent.

28. The device of claim 27, wherein the sensor for the peracetic acid content is an amperometric sensor.

29. The device of claim 27, wherein the conduit for emptying the ballast water tank is provided with a measuring device for salinity actuating the metering device for a reducing agent.

30. The device of claim 27, wherein the conduit for emptying the ballast water tank is provided with a sensor for the hydrogen peroxide content actuating the metering device for a reducing agent.

31. The device of claim 23, wherein a device for separating particles having a size in the range from 2 to 100 μm is arranged in the conduit for filling the ballast water tank upstream of the metering devices for equilibrium peracetic acid and catalase.
